(19) United States
(12) Patent Application Publication
(10) Pub. No.: US 2016/0148217 A1
(43) Pub. Date: May 26, 2016

(54) APPLICATION SHARING SERVICE METHOD AND APPARATUS APPLIED THERETO

(71) Applicant: Yong Jin KIM, Seoul (KR)

(72) Inventors: Yong Jin Kim, Seoul (KR); Seung Hyuk Her, Incheon (KR)

(21) Appl. No.: 14/899,845

(22) PCT Filed: Mar. 25, 2014
(86) PCT No.: PCT/KR2014/002498

§ 371 Date: Dec. 18, 2015

(30) Foreign Application Priority Data
Jun. 19, 2013 (KR) 10-2013-0070568

(51) Int. Cl. G06Q 30/00

(52) U.S. Cl. CPC G06Q 30/0185

(57) ABSTRACT

The present invention discloses an application sharing service method and a device applied to the service method. That is, a company service device can be enabled to provide service content by sharing an application by selecting, among the applications which are installed on a terminal device, a target application to be shared which can be shared with the company service device, and enabling the terminal device to access the service content which is provided by the company service device through the selected target application to be shared.

### TECHNICAL FIELD

The present invention relates to a method of selecting a target application to be shared, which can be shared with a company service device, among applications which are installed on a terminal device, and enabling a terminal device to have access to service content, which is provided by the company service device, through the selected target application to be shared.

### BACKGROUND ART

As smart phones are widely used, more and more companies are trying to improve corporation competition power by providing mobile services.

Most of these companies develop company applications of their own and are struggling to distribute the applications as wide as possible.

On the other hand, majority of smart phone users tend to download the applications which are developed and distributed mainly for a widespread use such as entertainment and communication, etc. rather than the company applications.

Therefore, when the company application is not distributed, the service of the company such as a customer service, information provision, etc. which is the objective of the company application cannot be provided normally, which is a drawback for the company.

Therefore, a method of providing the service of the company in a normal way, even when the company application is not distributed, is highly required.

### DETAILED DESCRIPTION OF THE INVENTION

### Technical Problem

The present invention is created by considering the situation mentioned above, and the objective to be accomplished by the present invention is to enable company service device to provide service content by sharing an application by selecting, among the applications which are installed on a terminal device, a target application to be shared which can be shared with the company service device, and enabling the terminal device to access the service content which is provided by the company service device through the selected target application to be shared.

### Technical Solution

A service device to accomplish the objective according to a first aspect of the present invention is characterized in comprising: a selecting unit which selects a target application to be shared which can be shared with a company service device among shared applications, which are registered in relation to the terminal device, according to a service request for the terminal device from the company service device; and a control unit which, when the target application to be shared is selected, enables the terminal device to have access to service content which is provided by the company service device via the selected target application to be shared.

More specifically, the service device further includes a registering unit which registers the shared application in relation to the terminal device, and the registering unit is characterized in that it registers, among all applications which are installed on the terminal device, only the application which is acknowledged to be sharable by the terminal device as the shared application for the terminal device.

More specifically, the target application to be shared is selected based on a sharing policy which is assigned to the company service device, and the selecting unit is characterized in that it selects, among all applications which are registered in relation to the terminal device, only the shared application which is acknowledged to be proper for the sharing policy as the target application to be shared.

More specifically, the sharing policy includes sharing target identification information for identifying the shared application which can be shared with the company service device, and the selecting unit is characterized in that it identifies, among all shared applications which are registered in relation to the terminal device, only the shared application which is matched with the sharing target identification information, and selects the identified shared application as the target application to be shared.

More specifically, the sharing policy includes priority discrimination information for discriminating priorities among shared applications which can be shared with the company service device, and when there are two or more shared applications which are acknowledged to be proper for the sharing policy, the selecting unit selects, among the two or more shared applications, the shared application which is discriminated to have a high priority based on the priority discrimination information, as the target application to be shared.

More specifically, when there are two or more shared applications with the same priority, the selecting unit selects, among the two or more shared applications, the shared application, which is acknowledged to have been executed most recently on the terminal device, as the target application to be shared.

More specifically, the service device further includes a determining unit for determining whether the target application to be shared has been installed on the terminal device, and the control unit is characterized in that, it enables the terminal device to have access to the service content which is provided by the company service device via the selected target application to be shared, only when it is determined in the determining unit that the target application to be shared has been installed on the terminal device.

More specifically, the service device further includes a providing unit which provides an access address for having access to the service content, and the control unit is characterized in that it enables the providing unit to provide the access address to the target application to be shared, which is being executed on the terminal device, such that the terminal device has access to the service content based on the access address.

An operating method to accomplish the objective according to a second aspect of the present invention is characterized in comprising: a selecting step of selecting a target application to be shared which can be shared with a company service device among shared applications which are registered in relation to the terminal device, according to a service request for the terminal device from the company service device; and

a controlling step of, when the target application to be shared is selected, enabling the terminal device to have access to service content which is provided by the company service device via the selected target application to be shared.

More specifically, the method further includes: a registering step of registering the shared application in relation to the terminal device, and, the registering step is characterized in registering, among all applications which are installed on the terminal device, only the application which is acknowledged to be sharable by the terminal device as the shared application for the terminal device.

More specifically, the target application to be shared is selected based on a sharing policy which is assigned to the company service device, and the selecting step is characterized in selecting, among all applications which are registered in relation to the terminal device, only the shared application which is acknowledged to be proper for the sharing policy as the target application to be shared.

More specifically, the sharing policy includes sharing target identification information for identifying the target application to be shared which is assigned to be sharable with the company service device, and the selecting step is characterized in selecting, among all shared applications which are registered in relation to the terminal device, the shared application which is matched with the sharing target identification information as the target application to be shared.

More specifically, the sharing policy includes priority discrimination information for discriminating priorities among shared applications which can be shared with the company service device, and when there are two or more shared applications which are acknowledged to be proper for the sharing policy, the selecting step is characterized in selecting, among the two or more shared applications, the shared application which is discriminated to have a high priority based on the priority discrimination information, as the target application to be shared.

More specifically, when there are two or more shared applications with the same priority, the selecting step is characterized in selecting, among the two or more shared applications, the shared application, which is acknowledged to have been executed most recently on the terminal device, as the target application to be shared.

More specifically, the method further includes: a determining step for determining whether the target application to be shared has been installed on the terminal device, and the controlling step is characterized in enabling the terminal device to have access to the service content which is provided by the company service device via the selected target application to be shared, only when it is determined in the determining step that the target application to be shared has been installed on the terminal device.

More specifically, the method further includes: a providing step of providing an access address for having access to the service content, and the controlling step is characterized in enabling, in the providing step, the access address to be provided to the target application to be shared, which is being executed on the terminal device, such that the terminal device has access to the service content based on the access address.

### Advantageous Effects

Therefore, according to the application sharing service method and the device applied to the service method according to the present invention, even when the company service device itself does not distribute a separate application for providing its service content or when the pre-distributed application is deleted, the service content can be provided in a normal way by sharing applications, which maximizes a user pool and greatly reduces the time and cost required for spreading the application, thereby enabling the mobile service to become popular, which is the ultimate objective of spreading of the applications.

### DESCRIPTION OF THE DRAWINGS

FIG. 1 is a schematical configuration diagram of an application sharing service system according to an embodiment of the present invention.

FIG. 2 is a configuration diagram according to one embodiment of the present invention.

FIG. 3 is a diagram for describing a sharing policy according to one embodiment of the present invention.

FIG. 4 is a schematical flowchart for describing an operation flow of the application sharing service system according to one embodiment of the present invention.

FIG. 5 is a schematical flowchart for describing an operation flow of the application sharing service system according to another embodiment of the present invention.

FIG. 6 is a schematical flowchart for describing an operation flow of the application sharing service system according to a further embodiment of the present invention.

FIG. 7 is a schematical flowchart for describing the operation flow of the service device according to one embodiment of the present invention.

### MODE OF THE INVENTION

Hereinafter, one embodiment of the present invention will be described in detail by referring to appended drawings.

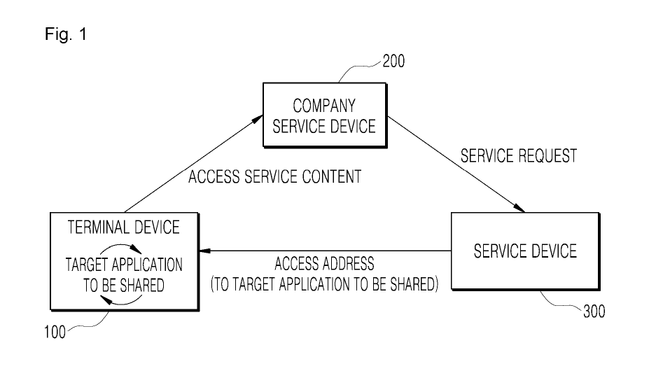

FIG. 1 is a diagram which shows an application sharing service system according to an embodiment of the present invention.

As shown in FIG. 1, the application sharing service system according to an embodiment of the present invention has a configuration including a company service device 200 which provides the service content toward the terminal device 100, and a service device 300 which enables the terminal device 100 to have access to the service content which is provided by the company service device 200.

Here, the terminal device 100 refers to a user device on which a plurality of applications can be installed and executed and which is able to have a voice call connection and data call connection with the company service device 200.

For example, the terminal device 100 can include a smart phone, a personal computer (PC), a notebook, a tablet PC, and a personal digital assistant (PDA), etc.; however the terminal device 100 is not limited to these and all devices, which can make a voice call connection and a data call connection, can be regarded as the terminal device 100.

Also, the company service device 200 refers to a service server which provides the service of its own to the terminal device 100.

This company service device 200 can provide a customer service as its own service as well as a guidance service and a part of an information provision service.

Here, the guidance service refers to a service which provides a service menu for voice guidance to the terminal device 100 using voice information, and, at the same time, additionally provides a service screen, which is synchronized with the voice information, to the terminal device 100 in the form of service content.

And, the service device 300 refers to the service server which enables the terminal device 100 to have access to the service content which is provided by the company service device 200 itself, and when a service request for the terminal device 100 is received from the company service device 200, the service device 300 operates to enable the terminal device 100 to have access to the service content which is provided by the company service device 200.

Meanwhile, according to an embodiment of the present invention, the terminal device 100 is allowed to have access to the service content which is provided by the company service device 200 itself.

In the case when the terminal device 100 has access to the service content, it is a normal case that the terminal device 100 has access to the service content by directly executing the company application which is developed and distributed by the company service device 200 itself.

Here, in case of the company application, it is mainly developed and distributed for the purpose of providing the service of the company itself such as a customer service, information provision, etc. rather than a common purpose such as entertainment/communications.

In this way, since the company application is developed and distributed for the purpose of supporting the service of the company itself, most users are reluctant to download the company application.

Even when the company application is downloaded, it can be deleted by users since it is not frequently used, and furthermore, it can disappear with the replacement of terminals as the terminal replacement period gets shorter and shorter.

Due to this situation, a method of readily providing the service of the company itself to users, even when the company application is not installed on the terminal device 100 is provided.

Therefore, according to this embodiment, there is provided a method of readily providing the service of the company itself to users, even when the applications, which are not developed and distributed by companies, are not installed on the terminal device, and this method will be described in more detail in the following.

At first, the terminal device 100 performs a function of registering the shared application on the service device 300.

More specifically, when the applications, which are installed on the terminal device 100, are updated, a service module, which is developed as a common program module for sharing applications, is added into the application which is being updated, and this addition will be notified to the service device 300, such that the service device 300 registers the corresponding application in the terminal device 100 as the shared application which is assigned for application sharing.

Also, the terminal device 100 performs a function of accessing the service content which is provided by the company service device 200.

More specifically, when the terminal device 100 connects to the company service device 200 (e.g., via a voice call connection) and requests the service provided by the company service device 200 itself, the terminal device 100 receives a push message from the service device 300, which is linked with the company service device 200, and access the service content provided by the company service device 200 based on an access address which is included in the push message.

In the meantime, the push message, which is received from the service device 300, is transmitted to wake up a specific application, which is selected as the target application to be shared among a plurality of shared application registered to correspond to the terminal device 100, on the service device 300.

Also, the service device 300 performs a function of registering the shared applications.

More specifically, when information for the applications, which have the service module for sharing applications, is received from the terminal device 100, the service device 300 registers the corresponding application as the shared application which corresponds to the terminal device 100.

Also, the service device 300 performs a function of selecting the target application to be shared.

More specifically, when a service request (search) for the terminal device 100 is received from the company service device 200 which has received the service request from the terminal device 100, the service device 300 selects the target application to be shared, which can be shared with the company service device 200, among the shared applications which are registered to correspond to the terminal device 100.

In the meantime, the service device 300 can acknowledge the sharing policy assigned to the company service device 200, choose the shared application which is proper for the sharing policy among all shared applications which are registered to correspond to the terminal device 100 according to the acknowledged sharing policy, and then select the chosen application as the target application to be shared which can be shared with the company service device 200.

Also, the service device 300 can perform a function of determining validity of the target application to be shared.

More specifically, when the selection for the target application to be shared is completed, the service device 300 determines whether the selected target application to be shared has been installed on the terminal device 100, and then determines the validity of the target application to be shared.

In the meantime, the service device 300 inquires to the terminal device 100 whether the target application to be shared is not deleted and remains installed based on an application identification (ID), and determines that the target application to be shared is valid when a positive response to the inquiry is received from the terminal device 100.

Also, the service device 300 performs a function of enabling the terminal device 100 to access the service content which is provided by the company service device 200.

More specifically, when it is determined that the selected target application to be shared is valid, the service device 300 provides a push message, which includes an access address used for accessing the service content provided by the company service device 200, to the terminal device 100, such that the terminal device 100 can access the service content which is provided by the company service device 200 based on the received access address.

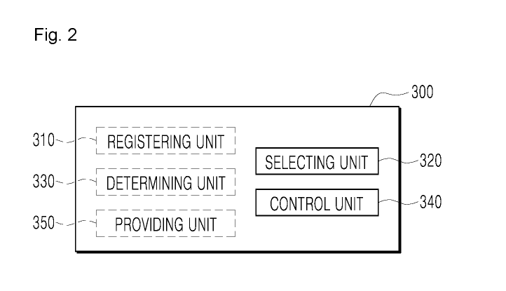

In the following, the configuration of the service device 300 according to an embodiment of the present invention will be explained in detail by referring to FIG. 2.

That is, the service device 300 has a configuration which includes a selecting unit 320 for selecting the target application to be shared among the shared applications which are registered to correspond to the terminal device 100, and a control unit 340 for enabling the terminal device 100 to access the service content which is provided by the company service device 200 through the target application to be shared.

Also, the service device 300 can have a configuration which, in addition to the aforementioned components, further includes a registering unit 310 for registering the shared applications for the terminal device 100, a determining unit 330 for determining validity of the target applications to be shared, and a providing unit 350 for providing the access address used for accessing the service content which is provided by the company service device 200.

Here, all or at least a portion of the aforementioned configuration of the service device 300 including the aforementioned registering unit 310, the selecting unit 320, the determining unit 330, the control unit 340, and the providing unit 350 can be implemented as a software module executed by a processor, a hardware module, or as a combination of the software module and the hardware module.

The registering unit 310 performs a function of registering the shared applications.

More specifically, when information for the applications, which have the service module for sharing applications, is received from the terminal device 100, the registering unit 310 registers the corresponding application as the shared application which corresponds to the terminal device 100.

In the meantime, the registering unit 310 receives the application ID, a user phone number, platform information of the terminal device 100 along with a message ID for delivering the push message for waking up the corresponding application, and registers the received information as the information which is related to the shared application.

Also, the selecting unit 320 performs a function of selecting the target applications to be shared.

More specifically, when a service request (search) for the terminal device 100 is received from the company service device 200 which has received the service request from the terminal device 100, the selecting unit 320 selects the target application to be shared, which can be shared with the company service device 200, among the shared applications which are registered to correspond to the terminal device 100.

In the meantime, the service device 320 can acknowledge the sharing policy assigned to the company service device 200, and selects the shared application which is acknowledged to be proper for the sharing policy among all shared applications which are registered to correspond to the terminal device 100 according to the acknowledged sharing policy, as the target application to be shared which can be shared with the company service device 200.

Here, the sharing policy can include a sharing target identification information for identifying the shared application, which can be shared with the company service device 200, and priority discrimination information for discriminating the priorities among the shared applications which can be shared with the company service device 200.

In connection with this, the selecting unit 320 identifies the shared application matched with the sharing target identification information among all the shared applications which are registered to correspond to the terminal device 100, and selects the identified shared application as the target application to be shared.

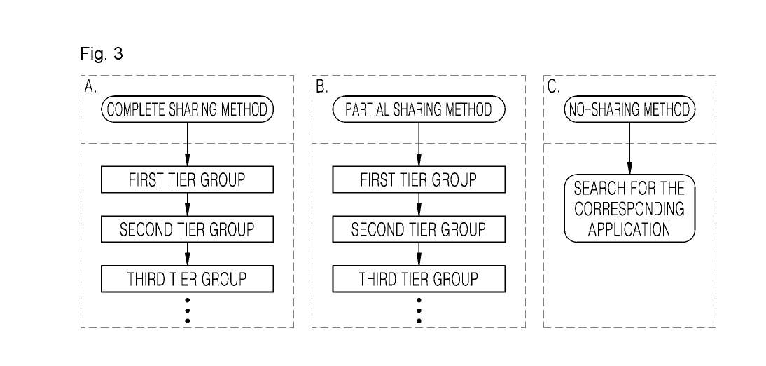

For example, the selecting unit 320 acknowledges the sharing method which is set by the company service device 200 based on the sharing target identification information from the following: a complete sharing method (A) in which, for example, all the shared applications, which are registered to correspond to the terminal device 100, can be shared as shown in FIG. 3; a partial sharing method (B) in which some applications, which are for example developed by some competing companies, are excluded from being used; and a no-sharing method (C) in which only the company applications, which are developed by the company itself, are used.

And, when the sharing method set by the company service device 200 is acknowledged, the selecting unit 320 selects the shared application which is proper for respective sharing methods among the all shared applications, which are registered to correspond to the terminal device 100, and when the selected shared application is only one, chooses the corresponding shared application and the target application to be shared.

Meanwhile, when there are a plurality of shared applications which are selected according to the sharing method set by the company service device 200, the selecting unit 320 can choose the shared application, whose priority is the highest among those for the selected shared applications based on the priority discrimination information included in the sharing policy, as the target application to be shared.

For example, with respect to the priorities among the shared applications, the shared applications can have the order of types of the shared applications as follows: a first tier group of applications which are preinstalled on the terminal device 100 by a manufacturer or a communication company and which are hardly deleted; a second tier group of applications which are frequently used by the user of the terminal device 100 for a communication purpose, such as a messenger, etc.; a third tier group of applications for the purpose of providing useful information such as news, etc. which are less likely to be used often but are needed to be installed; a fourth tier group of application which the rest applications excluding the first to third tier groups.

In the meantime, when it is determined that there are a plurality of shared applications having the same priorities, the selecting unit 320 can select the shared application, which is acknowledged to have been executed on the terminal device 100 most recently among the determined shared applications, as the target application to be shared.

Here, in the case where the terminal device 100 acknowledges the most recently executed shared application, the most recently executed application can be selected by additionally collecting log information related to the execution of the application from the terminal device 100, and identifying the application ID in the log information.

Also, the determining unit 330 can perform a function of determining validity of the target application to be shared.

More specifically, when the selection for the target application to be shared is completed, the determining unit 330 determines whether the selected target application to be shared has been installed on the terminal device 100, and then determines the validity of the target application to be shared.

In the meantime, the determining unit 330 inquires to the terminal device 100 whether the target application to be shared is not deleted and remains installed based on an application identification (ID), and determines that the target application to be shared is valid when a positive response to the inquiry is received from the terminal device 100.

Meanwhile, when no response is received from the terminal device 100 to the inquiry on whether the shared application has already been installed, the determining unit 330 repeatedly inquires for the number of times set according to a period (e.g.: 3 times), and, when no response is received after the set number is exceeded, the determining unit considers that the selected target application to be shared is deleted from the terminal device 100 to finally confirm that the target application to be shared is unavailable.

Of course, the target application to be shared, which is confirmed as unavailable, is to be deleted from a list of target applications to be shared which are registered to correspond to the terminal device 100, while, when the response to the inquiry on whether the target application to be shared is installed is received before the set number is exceeded, the counter is preferably initialized.

And, the control unit 340 performs a function of enabling the terminal device 100 to access the service content which is provided by the company service device 200.

More specifically, when it is determined that the selected target application to be shared is valid, the control unit 340 provides a push message, which includes an access address used for accessing the service content provided by the company service device 200, to the terminal device 100, such that the terminal device 100 can access the service content which is provided by the company service device 200 based on the received access address.

In the meantime, the providing unit 350 transmits the push message to wake up the target application to be shared, which is determined to be installed on the terminal device 100, in order to enable the terminal device 100 to acknowledge the access address included in the push message using the target application to be shared and access the service content which is provided by the company service device 200.

As described in the above, according to the application sharing service system according to an embodiment of the present invention, the target application to be shared to be shared with the company service device 200 is selected from the applications installed on the terminal device 100, and the terminal device 100 is enabled to access the service content which is provided by the company service device 200 through the selected target application to be shared; therefore, the service content can be provided in a normal way by sharing the application even when the company service device 200 itself does not distribute a separate application for providing its service content or when the pre-distributed application is deleted from the terminal device. Also, the use pool can be maximized by sharing applications, the time and cost for spreading the application can be greatly reduced application, and, therefore, the mobile service can get to be popular, which is an ultimate purpose of distributing applications.

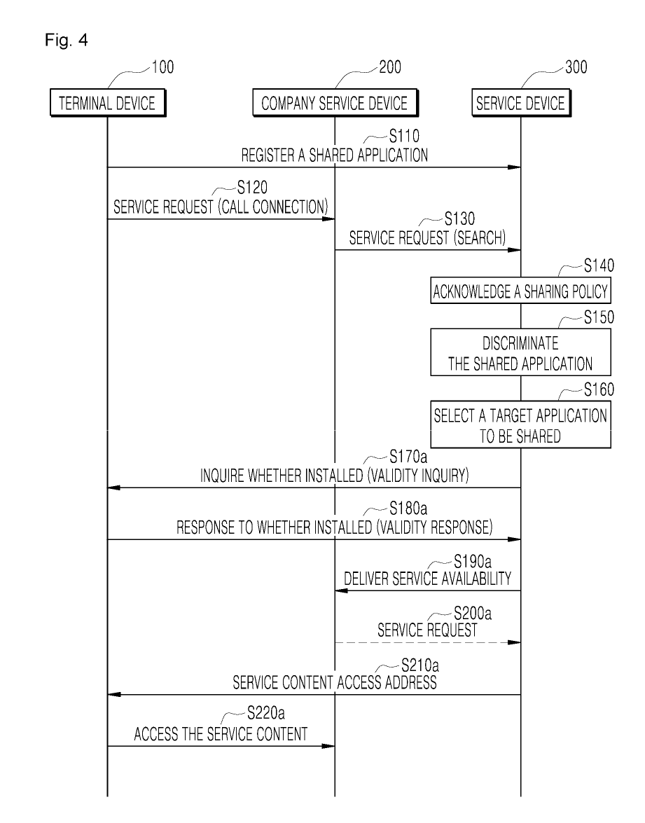

In the following, an application sharing service method according to an embodiment of the present invention is described by referring to FIGS. 4-7.

Here, the configurations described in the FIGS. 1 and 3 are referred to by using corresponding reference numbers for the convenience of description.

At first, the operation flow in the application sharing service system according to an embodiment of the present invention will be explained by referring to FIG. 4.

At first, when the applications, which are installed on the terminal device 100, are updated, a service module, which is developed as a common program module for sharing applications, is added into the application which is being updated, and this addition will be notified to the service device 300, such that the service device 300 registers the corresponding application in the terminal device 100 as the shared application which is assigned for application sharing (S110).

Then, when a service request (search) for the terminal device 100 is received from the company service device 200 which has received the service request from the terminal device 100, the service device 300 selects the target application to be shared, which can be shared with the company service device 200, among the shared applications which are registered to correspond to the terminal device 100 (S120-S160).

In the meantime, the service device 300 can acknowledge the sharing policy assigned to the company service device 200, choose the shared application which is proper for the sharing policy among all shared applications which are registered to correspond to the terminal device 100 according to the acknowledged sharing policy, and then select the chosen application as the target application to be shared which can be shared with the company service device 200.

After doing so, when the selection for the target application to be shared is completed, the service device 300 determines whether the selected target application to be shared has been installed on the terminal device 100, and then determines the validity of the target application to be shared (S170a-S190a).

In the meantime, the service device 300 inquires to the terminal device 100 whether the target application to be shared is not deleted and remains installed based on an application identification (ID), determines that the target application to be shared is valid when a positive response to the inquiry is received from the terminal device 100, and notifies to the company service device 200 that the sharing service is available.

Furthermore, when it is determined that the selected target application to be shared is valid, the service device 300 provides a push message, which includes an access address used for accessing the service content provided by the company service device 200, to the terminal device 100, such that the terminal device 100 can access the service content which is provided by the company service device 200 based on the received access address (S190a-S220a).

In the meantime, the service device 300 transmits the push message to wake up the target application to be shared, which is determined to be installed on the terminal device 100, in order to enable the terminal device 100 to acknowledge the access address included in the push message using the target application to be shared and access the service content which is provided by the company service device 200.

Meanwhile, when a service request is received from the company service device 200, which is notified of the fact that the sharing service is available, the service device 300 provides the push message including the access address used for accessing the service content; however, this process (S190a) can be omitted.

As a reference, according to an embodiment of the present invention, in the process (S190a) in which the service device 300 notifies to the company service device 200 that the sharing service is available as mentioned above, it is possible to implement the company service device 200 to directly deliver the access address used for accessing the service content to the terminal device 100 such that the terminal device 100 can access the service content which is provided by the company service device 200.

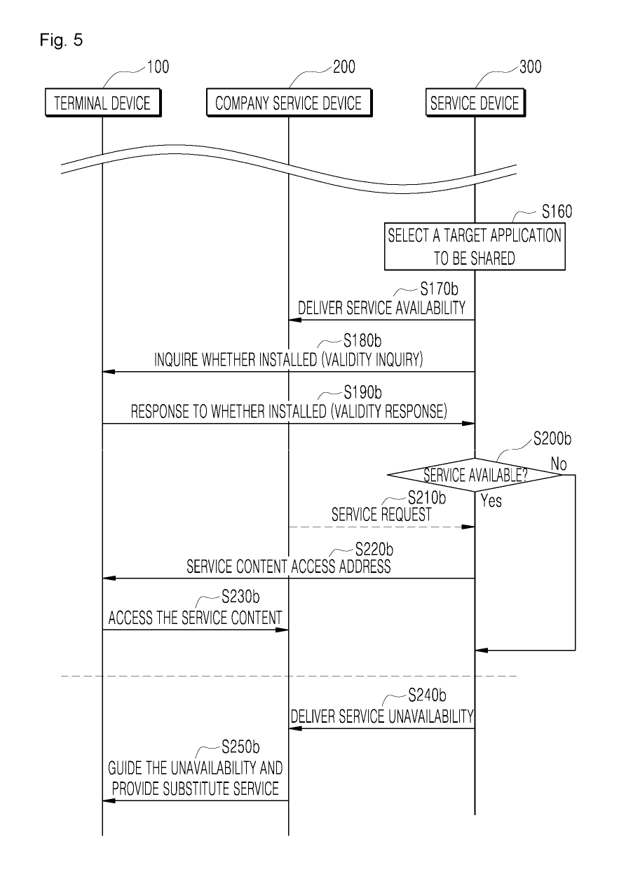

In the following, the operation flow in the application sharing service system according to another embodiment of the present invention will be explained by referring to FIG. 5.

Meanwhile, the operation flow, up to the selecting process (S160) of the target application to be shared, of the application sharing service system according to another embodiment of the present invention is the same as the operation flow of the application sharing service system according to an embodiment of the present invention, and, therefore, it is omitted in the following description.

At first, when the selection of the target applications to be shared is completed, the service device 300 notifies to the company service device 200 that the sharing service is available (S170b-S180b).

Likewise, the company service device 200 is notified of the fact that the sharing service is available before determining the validity of the target application to be shared, and it is done in order to minimize the load for maintaining a channel for connecting the company service device 200 with the terminal device 100 from the transmission of the validity inquiry to the reception of the response from the terminal device 100.

When it is notified to the company service device 200 that the sharing service is available before determining the validity of the target application to be shared, the company service device 200 can guide the user to use the sharing service, and can also prevent a service delay due to the validity determination by enabling the service device 300 to perform the validity inspection in parallel with the guidance.

After doing so, the service device 300 determines whether the selected target application to be shared has been installed on the terminal device 100, and then determines the validity of the target application to be shared (S190b-S210b).

In the meantime, the service device 300 inquires to the terminal device 100 whether the target application to be shared is not deleted and remains installed based on an application identification (ID), determines that the target application to be shared is valid when a positive response to the inquiry is received from the terminal device 100, and finally confirms that the sharing service can be used via the corresponding target application to be shared.

Furthermore, when it is determined that the selected target application to be shared is valid, the service device 300 provides a push message, which includes an access address used for accessing the service content provided by the company service device 200, to the terminal device 100 according to the service request received from the company service device 200, such that the terminal device 100 can access the service content which is provided by the company service device 200 based on the received access address (S220b-S240b).

Here, when a service request is received from the company service device 200, which is notified of the fact that the sharing service is available, the service device 300 provides the push message including the access address used for accessing the service content; however, this process (S220b) can be omitted.

Meanwhile, when no response is received from the terminal device 100 to the inquiry on whether the shared application has already been installed, the service device 300 repeatedly inquires for the number of times set according to a period (e.g.: 3 times), and, when no response is received after the set number is exceeded, the determining unit considers that the selected target application to be shared is deleted from the terminal device 100 to finally confirm that the target application to be shared is unavailable (S230b, S250b-S260b).

In the meantime, when it is finally confirmed that the target application to be shared is unavailable, the service device 300 notifies this to the company service device 200, such that the company service device 200 can guide this unavailability and provide substitute services to the terminal device 100.

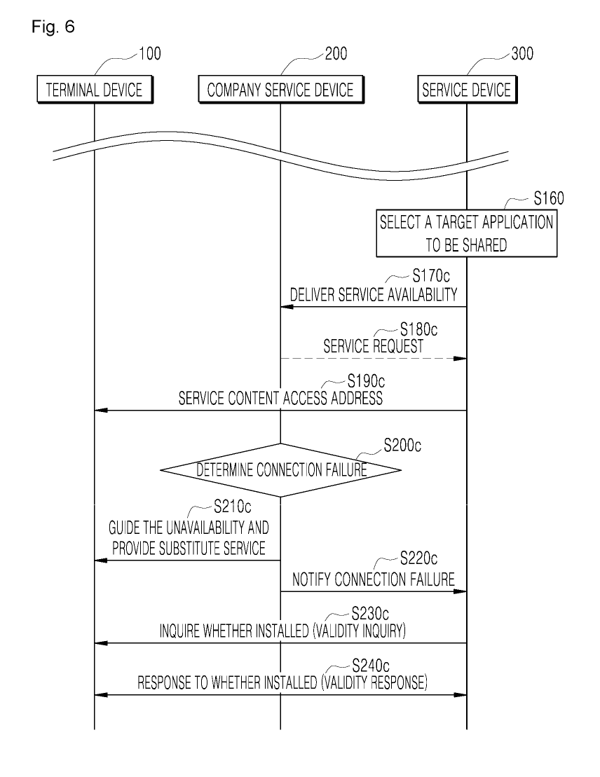

In the following, the operation flow in the application sharing service system according to a further embodiment of the present invention will be explained by referring to FIG. 6.

Meanwhile, the operation flow, up to the selecting process (S160) of the target application to be shared, of the application sharing service system according to a further embodiment of the present invention is the same as the operation flow of the application sharing service system according to an embodiment of the present invention, and, therefore, it is omitted in the following description.

At first, when the selection of the target applications to be shared is completed, the service device 300 notifies to the company service device 200 that the sharing service is available (S170c).

Then, the service device 300 provides a push message, which includes an access address used for accessing the service content provided by the company service device 200, to the terminal device 100 according to the service request received from the company service device 200, such that the terminal device 100 can access the service content which is provided by the company service device 200 based on the received access address (S180c-S190c).

Here, when a service request is received from the company service device 200, which is notified of the fact that the sharing service is available, the service device 300 provides the push message including the access address used for accessing the service content; however, this process (S180c) can be omitted.

After doing so, when the terminal device 100 does not try to access the service for a set time period, the company service device 200 regards this situation as a service access failure and notifies this to the service device 300, such that the service device 300 proceeds to the validity determination for the target application to be shared (S200c-S220c).

Like this, the validity is inspected after the service access failure occurs, and it is done because the load due to maintaining of a channel between the company service device 200 and the terminal device 100 from the validity inquiry to the reception of the response from the terminal device 100 is distributed to a time period during which it is less likely that the service is used, thereby distributing the system load.

In the meantime, when the service access failure is determined for the terminal device 100, the failure is notified to the terminal device 100 and a substitute service is provided.

After so, when the service access failure is notified from the company service device 200, the service device 200 determines whether the selected target application to be shared has been installed on the terminal device 100, and then determines the validity of the target application to be shared (S203c-S240c).

In the meantime, the service device 300 inquires to the terminal device 100 whether the target application to be shared is not deleted and remains installed based on an application identification (ID), and when no response to the inquiry is received even when the set number is exceeded, the selected target application to be shared is regarded as being deleted from the terminal device 100, and the application is finally confirmed to be unavailable.

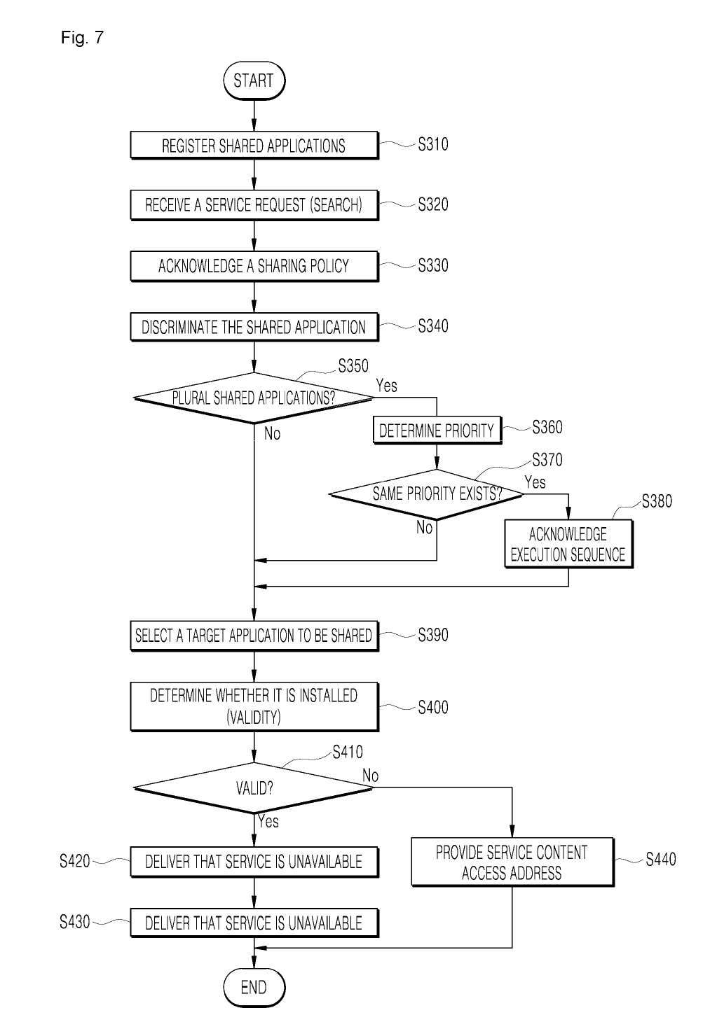

In the following, operation method of the service device 300 according to an embodiment of the present invention will be explained in detail by referring to FIG. 7.

At first, when information for the applications, which have the service module for sharing applications, is received from the terminal device 100, the registering unit 310 registers the corresponding application as the shared application which corresponds to the terminal device 100 (S310).

In the meantime, the registering unit 310 receives the application ID, a user phone number, platform information of the terminal device 100 along with a message ID for delivering the push message for waking up the corresponding application, and registers the received information as the information which is related to the shared application.

After doing so, when a service request (search) for the terminal device 100 is received from the company service device 200 which has received the service request from the terminal device 100, the selecting unit 320 chooses the shared application, which is acknowledged to be proper for a sharing policy, by acknowledging the sharing policy assigned to the company service device 200, and then selects the chosen shared application as the target application to be shared which can be shared with the company service device 200 (S320-S340).

In the meantime, when there are a plurality of shared applications which are selected according to the sharing method set by the company service device 200, the selecting unit 320 chooses the shared application, whose priority is the highest among those for the selected shared applications based on the priority discrimination information included in the sharing policy, as the target application to be shared (S350-S370, S390).

Here, when it is determined that there are a plurality of shared applications having the same priorities, the selecting unit 320 can select the shared application, which is acknowledged to have been executed on the terminal device 100 most recently among the determined shared applications, as the target application to be shared (S370-S390).

After doing so, when the selection for the target application to be shared is completed, the determining unit 330 determines whether the selected target application to be shared has been installed on the terminal device 100, and then determines the validity of the target application to be shared (S400).

In the meantime, the determining unit 330 inquires to the terminal device 100 whether the target application to be shared is not deleted and remains installed based on an application identification (ID), and determines that the target application to be shared is valid when a positive response to the inquiry is received from the terminal device 100.

Meanwhile, when nor response is received from the terminal device 100 to the inquiry on whether the shared application has already been installed, the determining unit 330 repeatedly inquires for the number of times set according to a period (e.g.: 3 times), and, when no response is received after the set number is exceeded, the determining unit considers that the selected target application to be shared is deleted from the terminal device 100 to finally confirm that the target application to be shared is unavailable.

After doing so, when it is determined that the selected target application to be shared is valid, the control unit 340 provides a push message, which includes an access address used for accessing the service content provided by the company service device 200, to the terminal device 100, such that the terminal device 100 can access the service content which is provided by the company service device 200 based on the received access address (S410-S430).

Meanwhile, when it is finally confirmed in the determining unit 330 that the target application to be shared is unavailable, the control unit 340 enables the providing unit 350 to notify this to the company service device 200, such that the company service device 200 can guide this unavailability and provide substitute services to the terminal device 100 (S410, S440).

As described in the above, according to the application sharing service method according to an embodiment of the present invention, the target application to be shared to be shared with the company service device 200 is selected from the applications installed on the terminal device 100, and the terminal device 100 is enabled to access the service content which is provided by the company service device 200 through the selected target application to be shared; therefore, the service content can be provided in a normal way by sharing the application even when the company service device 200 itself does not distribute a separate application for providing its service content or when the pre-distributed application is deleted from the terminal device. Also, the use pool can be maximized by sharing applications, the time and cost for spreading the application can be greatly reduced application, and, therefore, the mobile service can get to be popular, which is an ultimate purpose of distributing applications.

Meanwhile, the method and algorithm steps which are described in relation to the embodiments disclosed herein can be implemented directly as a hardware, as a software module executed by a processor, or as a combination of the hardware and the software module. The software module may reside in RAM memory, flash memory, ROM memory, EPROM memory, EEPROM memory, registers, a hard disk, a removable disk, a CD-ROM, or any other form of storage medium known in the art. The exemplary storage medium can be connected to the processor, and, as a result, the processor can read information from the storage medium and record the information on the storage medium. Alternatively, the storage medium can be incorporated in the processor. The processor and the storage medium can be included in an ASIC. The ASIC can be included in the user terminal device. Alternately, the processor and the storage medium can be included as separate components in the user terminal device.

Although the present invention is explained in detail by referring to preferred embodiments, the present invention is not restricted to these embodiments; and it is to be understood that the technical scope of the present invention encompasses the range in which any person with an ordinary skill in the art can readily modify or change the embodiments without departing from the subject matter of the present invention defined in the appended claims.

### INDUSTRIAL APPLICABILITY

According to the application sharing service method and the device applied to the same according to an embodiment of the present invention, it is possible to provide the service content in a normal way by sharing applications even when the company service device does not distribute a separate application for providing its service content or when the pre-distributed application is deleted, and, therefore, the limit of the prior art is overcome, the device to which the invention applies can be marketed with competitive power, and the device can be apparently practiced, which guarantees the industrial applicability of the present invention.

1. A service device characterized in comprising:
a selecting unit which selects a target application to be shared which can be shared with a company service device among shared applications which are registered in relation to the terminal device, according to a service request for the terminal device from the company service device; and
a control unit which, when the target application to be shared is selected, enables the terminal device to have access to service content which is provided by the company service device via the selected target application to be shared.

2. The service device according to claim 1, wherein the service device further includes a registering unit which registers the shared application in relation to the terminal device, and
the registering unit is characterized in that it registers, among all applications which are installed on the terminal device, only the application which is acknowledged to be sharable by the terminal device as the shared application for the terminal device.

3. The service device according to claim 1, wherein the target application to be shared is selected based on a sharing policy which is assigned to the company service device, and
the selecting unit is characterized in that it selects, among all shared applications which are registered in relation to the terminal device, only the shared application which is acknowledged to be proper for the sharing policy as the target application to be shared.

4. The service device according to claim 3, wherein the sharing policy includes sharing target identification information for identifying the shared application which can be shared with the company service device, and
the selecting unit is characterized in that it identifies, among all shared applications which are registered in relation to the terminal device, only the shared application which is matched with the sharing target identification information, and selects the identified shared application as the target application to be shared.

5. The service device according to claim 3, wherein the sharing policy includes priority discrimination information for discriminating priorities among shared applications which can be shared with the company service device, and
when there are two or more shared applications which are acknowledged to be proper for the sharing policy, the selecting unit selects, among the two or more shared applications, the shared application which is discriminated to have a high priority based on the priority discrimination information, as the target application to be shared.

6. The service device according to claim 5, wherein, when there are two or more shared applications with the same priority, the selecting unit selects, among the two or more shared applications, the shared application, which is acknowledged to have been executed most recently on the terminal device, as the target application to be shared.

7. The service device according to claim 1, wherein the service device further includes a determining unit for determining whether the target application to be shared has been installed on the terminal device, and
the control unit is characterized in that, it enables the terminal device to have access to the service content which is provided by the company service device via the selected target application to be shared, only when it is determined in the determining unit that the target application to be shared has been installed on the terminal device.

8. The service device according to claim 1, wherein the service device further includes a providing unit which provides an access address for having access to the service content, and
the control unit is characterized in that it enables the providing unit to provide the access address to the target application to be shared, which is being executed on the terminal device, such that the terminal device has access to the service content based on the access address.

9. An operating method for a service device characterized in comprising:
a selecting step of selecting a target application to be shared which can be shared with a company service device among shared applications which are registered in relation to the terminal device, according to a service request for the terminal device from the company service device; and
a controlling step of, when the target application to be shared is selected, enabling the terminal device to have access to service content which is provided by the company service device via the selected target application to be shared.

10. The operating method for a service device according to claim 9, wherein the method further includes:
a registering step of registering the shared application in relation to the terminal device, and
the registering step is characterized in registering, among all applications which are installed on the terminal device, only the application which is acknowledged to be sharable by the terminal device as the shared application for the terminal device.

11. The operating method for a service device according to claim 9, wherein the target application to be shared is selected based on a sharing policy which is assigned to the company service device, and
the selecting step is characterized in selecting, among all shared applications which are registered in relation to the terminal device, only the shared application which is acknowledged to be proper for the sharing policy as the target application to be shared.

12. The operating method for a service device according to claim 11, wherein the sharing policy includes sharing target identification information for identifying the target application to be shared which is assigned to be sharable with the company service device, and
the selecting step is characterized in selecting, among all shared applications which are registered in relation to the terminal device, the shared application which is matched with the sharing target identification information as the target application to be shared.

13. The operating method for a service device according to claim 11, wherein the sharing policy includes priority discrimination information for discriminating priorities among shared applications which can be shared with the company service device, and
when there are two or more shared applications which are acknowledged to be proper for the sharing policy, the selecting step is characterized in selecting, among the two or more shared applications, the shared application which is discriminated to have a high priority based on the priority discrimination information, as the target application to be shared.

14. The operating method for a service device according to claim 13, wherein, when there are two or more shared applications with the same priority, the selecting step is characterized in selecting, among the two or more shared applications, the shared application, which is acknowledged to have been executed most recently on the terminal device, as the target application to be shared.

15. The operating method for a service device according to claim 9, wherein the method further includes:
a determining step for determining whether the target application to be shared has been installed on the terminal device, and
the controlling step is characterized in enabling the terminal device to have access to the service content which is provided by the company service device via the selected target application to be shared, only when it is determined in the determining step that the target application to be shared has been installed on the terminal device.

16. The operating method for a service device according to claim 9, wherein the method further includes:
a providing step of providing an access address for having access to the service content, and
the controlling step is characterized in enabling, in the providing step, the access address to be provided to the target application to be shared, which is being executed on the terminal device, such that the terminal device has access to the service content based on the access address.
